(19) United States
(12) Patent Application Publication
(10) Pub. No.: US 2019/0301609 A1
(43) Pub. Date: Oct. 3, 2019

(54) GASKET

(71) Applicant: AFGlobal UK Limited, Knaphill Surrey (GB)

(72) Inventor: Kieren SCHNEIDER, Knaphill Surrey (GB)

(21) Appl. No.: 16/322,798

(22) PCT Filed: Aug. 4, 2017
(86) PCT No.: PCT/IB2017/054805

§ 371 Date: Feb. 1, 2019

(30) Foreign Application Priority Data
Aug. 4, 2016 (GB) 1613459.5

(51) Int. Cl. F16J 15/08; F16J 15/06; F16L 17/08

(52) U.S. Cl. CPC F16J 15/0881; F16J 15/061; F16L 23/20; F16L 17/08; F16J 15/062

(57) ABSTRACT

Provided is a seal ring (14), such as a gasket, for use in connecting the end of a first conduit to the end of second conduit or other installation, in subsea environments. A metal gasket for providing a sealing connection between first and second tubular members comprises: two opposing side surfaces (30), each side surface comprising an annular recess (36) for receiving an elastomeric annular sealing member, an outer circumferential surface (26) comprising an annular rib portion (32), and an inner circumferential surface (28) comprising an annular channel (34). The gasket further comprises a first pair of annular tapered surfaces (38, 40) between the side surfaces and the outer circumferential surface; and a second pair of annular tapered surfaces (42, 44) between the side surfaces and the inner circumferential surface.

This application claims the benefit of priority to United Kingdom Patent Application Serial No. 1613459.5, filed Aug. 4, 2016, hereby incorporated by reference in its entirety.

This invention relates to a seal ring for use in the connection of conduits and the like in a subsea environment.

### BACKGROUND

When connecting adjacent sections of fluid flow conduits seal rings, such as gaskets, are typically interposed at the interface of adjacent connecting flanged conduits, which are then bolted or clamped together.

The annular metallic seal ring, provided at the interface between the flanged hubs of the conduits, prevents fluid leaking out of the fluid flow path. In a subsea deepwater environment the seal may have to withstand internal and/or external pressures equivalent to depths in the order of 5000 m or above of sea water without leakage of fluid at the interface.

A number of difference gaskets have been proposed for subsea use, such as AX style gaskets, however these have limited deepwater resistance. Gaskets with double sealing faces such as the Vector Duoseal™ have also been proposed, however application of either internal or external pressure reduces sealing load on opposing sealing faces.

The present invention seeks to provide a gasket and sealing assembly for use subsea in deepwater environments.

### SUMMARY OF THE INVENTION

The invention provides a seal ring, such as a gasket, for use in connecting the end of a first conduit to the end of a second conduit or other installation, in subsea environments.

Accordingly one aspect of the invention provides a metal gasket for providing a sealing connection between first and second tubular members, each tubular member having an end face comprising an annular recess for receiving the gasket, each recess comprising tapered side walls, the gasket comprising:

two opposing side surfaces, each side surface comprising an annular recess for receiving an annular sealing member;
an outer circumferential surface comprising an annular rib portion; and
an inner circumferential surface comprising an annular channel;
the gasket further comprising a first pair of annular tapered surfaces between the side surfaces and the outer circumferential surface; and
a second pair of annular tapered surfaces between the side surfaces and the inner circumferential surface.

The first and second pair of annular tapered surfaces are configured to abut the tapered side walls of the annular recess of the tubular members, when the gasket is fitted between the tubular members.

The first pair of annular tapered surfaces comprise first and second outwardly facing tapered surfaces connecting the side walls to the outer circumferential surface. The second pair of annular tapered surfaces comprise first and second inwardly facing tapered surfaces connecting the side walls to the inner circumferential surface. The outwardly facing tapered surfaces acts as displacement stop surfaces. The inwardly facing tapered surfaces acting as sealing surfaces of the gasket.

As such, each side section of the gasket has an outwardly tapered surface, from the first pair of annular tapered surfaces, a central side surface comprising the annular recess and an inwardly tapered surface, from the second pair of annular tapered surfaces.

The first and second outwardly tapered surfaces extend from the side surfaces to the outer circumferential surface and are tapered at a first angle, such that the width between the opposing side surfaces is greater than the width of the outer circumferential surface. The first and second inwardly tapered surfaces extend from the side walls to the inner circumferential surface and are tapered at a second angle, such that the width between the opposing side surfaces is greater than the width of the inner circumferential surface.

The first and second angles can be different. Preferably the first and second outwardly tapered surfaces are tapered at a smaller angle than the first and second inwardly tapered sealing surfaces.

In one embodiment the first and second tapered outwardly surfaces can be tapered at an angle from about 20° to 35° from the horizontal. Preferably the surfaces are tapered at an angle of from about 26° to 30°, more preferably from about 27.5° to 28.5°.

The first and second inwardly tapered sealing surfaces can be tapered at an angle from about 60° to 75° to the horizontal. Preferably the surfaces are tapered at an angle of from about 66° to 70°, more preferably from about 68° to 68.5°.

At an angle from the horizontal means the tapered surfaces taper angle (α) is measured from a line parallel to the central bore axis of the gasket.

The distance from the outer circumferential surface to the recess is greater than the distance from the base of the channel in the inner circumferential surface to the recess. The distance from the base of the channel to the annular recess may be about 10 to 30%, preferably 15 to 25%, more preferably 17 to 22% of the total distance from the outer circumferential surface to the base of the channel in the inner circumferential surface.

The length of the side surfaces above the annular recess may be greater than the length of the side surface below the annular recess. Preferably the length of the side surfaces below the annular recess is 15 to 25% of the total length of the side wall. The total length of the side wall includes the width of the opening of the annular recess.

The base of the channel may comprise a major portion of the inner circumferential surface. The channel may have a depth such that it does not extend beyond where the inwardly tapered surfaces join to the side surfaces. In one embodiment the channel can have a depth of from 5 cm to 10 mm, preferably the channel has a depth of from 6 mm to 7 mm.

The rib may extend from a central portion of the outer circumferential surface. The rib can have a height of from 3 mm to 10 mm, preferably the rib has a height of from 3.75 mm to 4.25 mm.

The gasket can be coated with a low friction coating. Coatings providing low coefficient of friction can be used on the surfaces of the gasket. Preferably the coating provides a friction co-efficient of about 0.02 to 0.06, preferably of about 0.04. A polymer coating, such as a polytetrafluoroethylene (PTFE) containing coating can be used.

The gasket can be composed of a different material than the tubular member faces. Preferably the gasket is composed of a softer material than the material of the tubular member end faces. Preferably the gasket can be made from a nickel alloy.

Having a hardness differential between the gasket and the mating hub seal faces of the tubular members, where the gasket is softer than the mating hub seal faces, contributes to an improved sealing performance of the gasket. Additionally, if the gasket is softer than the seal faces of the mating hubs, any particles present during makeup will be forced into the softer gasket, which is retrievable from subsea and reduces the risk of damaging the hubs which are permanently installed subsea.

A further aspect of the invention provides a sealing assembly for providing a sealing connection between first and second tubular members, each tubular member having an end face comprising an annular recess for receiving a gasket, the recess comprising tapered side walls, the sealing assembly comprising:

a metal gasket having:
two opposing side surfaces, each side surface comprising an annular recess for receiving annular sealing members;
an outer circumferential surface comprising a rib portion;
an inner circumferential surface comprising a channel;
the metal gasket further comprising a first pair of annular tapered surfaces between the side surfaces and the outer circumferential surface and a second pair of annular tapered surfaces between the side surfaces to the inner circumferential surface;
an annular seal plate for retaining the metal gasket coaxially to the seal plate, the seal plate comprising an annular recess located in its inner surface for retaining the rib of the metal gasket; and annular sealing members for mounting in the annular recesses of the side walls of the gasket.

Preferably the sealing members are elastomeric sealing ring, such as elastomeric O-rings. Preferably the sealing members are composed of a fluorocarbon elastomer.

The annular seal plate can comprise an outer plate and an inner plate, wherein the inner plate has a smaller diameter than the outer plate; is mounted coaxially with the outer seal plate to define the annular recess therein between.

The inner surface of the outer plate can have a shoulder extending therefrom and the outer circumferential surface of the inner plate can abut the inner surface of the outer plate the outer plate to define the annular recess between the inner plate and the shoulder portion. The width of the inner plate can be smaller than the width of the outer plate.

The terms “inwardly” and “outwardly”, “inner” and “outer” and “top” and “bottom” as used herein are relative and used with reference to the figures. The term “outer” is understood to mean the section that is closest to the environment outside of the tubular members and/or the surface facing outwards. The term “inner” is understood to mean the section that is closest to the bore of the tubular members and/or the surface facing inwards towards the bore of the tubular members. For example the term “outer surface” is understood to mean the top surface of the gasket and the term “inner surface” and is understood to mean the bottom surface of the gasket.

### BRIEF DESCRIPTION OF THE DRAWINGS

Embodiments of the present invention will now be described, by way of example only with reference to the accompanying drawings, in which:

FIG. 1 is a sectional view showing an embodiment of the sealing assembly;

FIG. 2 is a sectional view showing an embodiment of the sealing assembly;

FIG. 3 is a schematic of the cross sectional shape of the gasket;

FIG. 4 is a perspective sectional view showing an embodiment of the sealing;

FIG. 5 is view of the sealing assembly and a hub;

FIG. 6 is sectional view of the sealing assembly;

FIG. 7 is a front view of the sealing assembly;

FIG. 8 is a front view of the gasket;

FIG. 9 is sectional view of the sealing assembly;

FIG. 10 is a section view of the sealing assembly;

FIG. 11 is a sectional front view of the sealing assembly; and

FIG. 12 is a sectional front view of the seal plate.

### DETAILED DESCRIPTION OF THE INVENTION

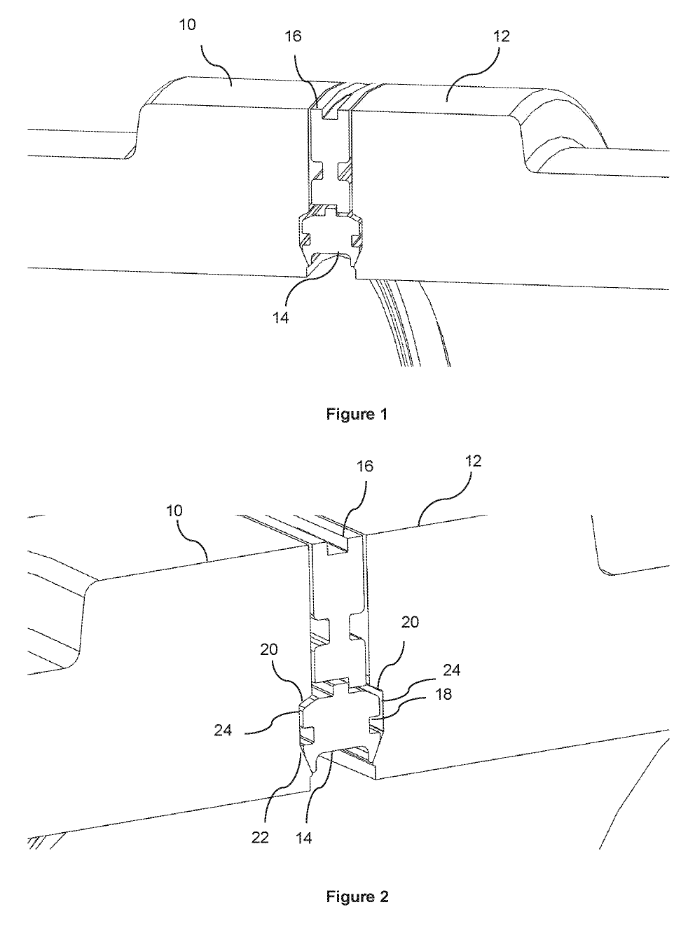

Referring to FIG. 1 the joint comprises first and second tubular members 10, 12 in the form of flanged hubs, a gasket 14 and a seal plate 16. The sealing assembly engages with the flanged hubs of the tubular members, with the gasket engaging via a recess 18 in the end faces of the hubs. The hubs of the tubular members are profiled to cooperate with the gasket, and each hub comprise a recess defined by outer (top) 20 and inner 22 (bottom) side walls that taper inwards from the flanged face to the base 24 of the recess, as shown in the FIGS. 1 and 2.

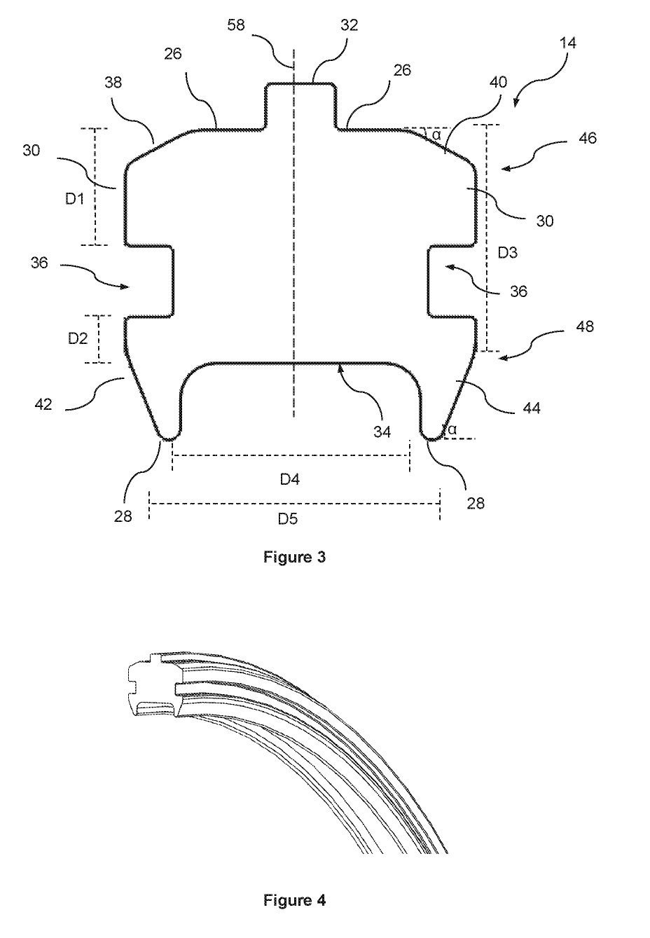

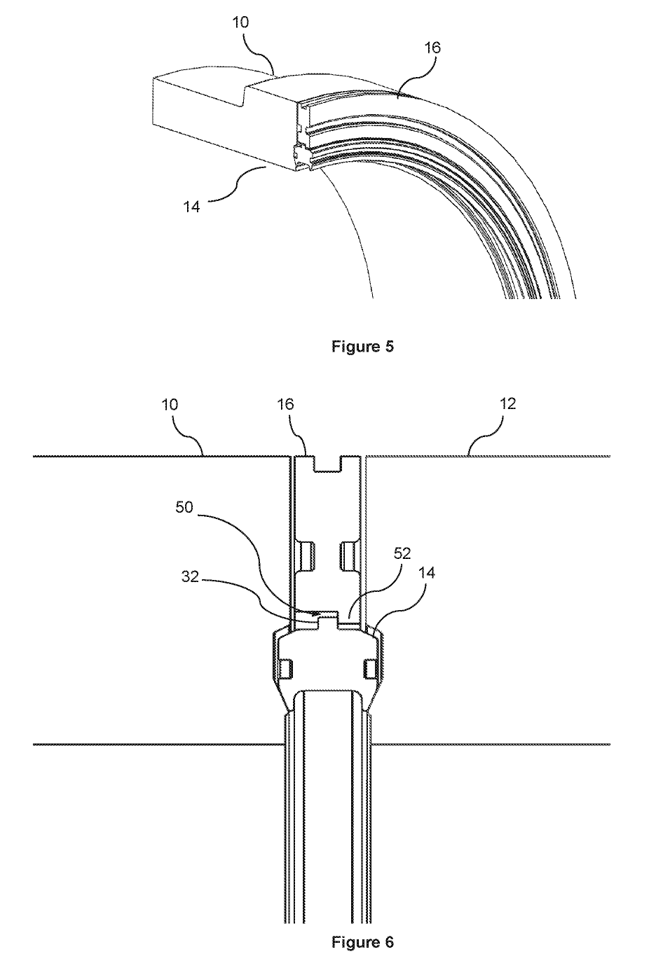

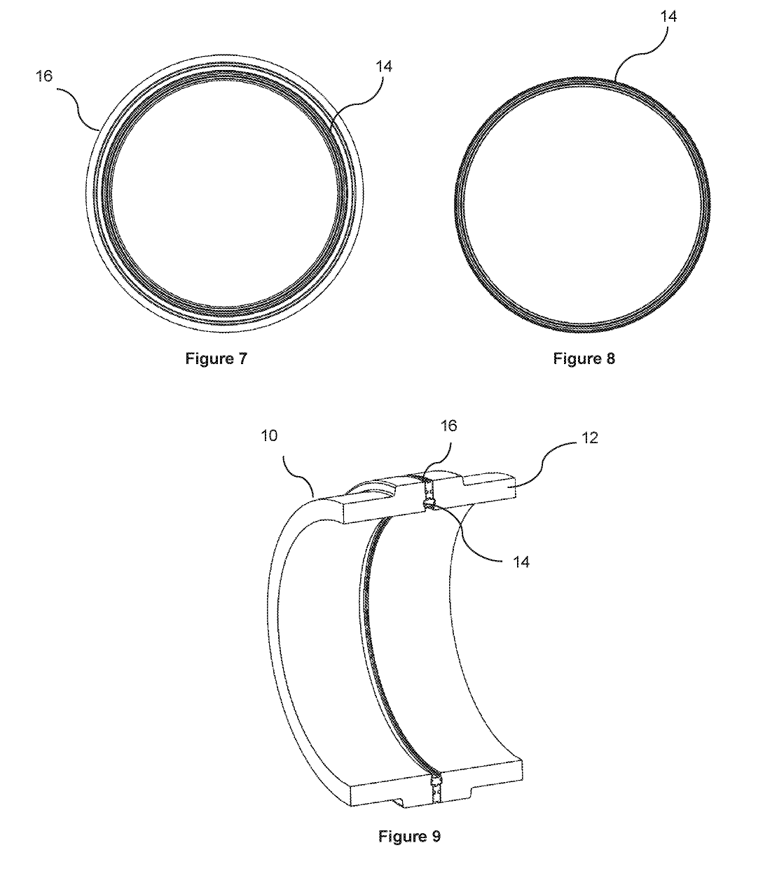

Referring to FIG. 3, the annular gasket 14 comprises an outer (top) circumferential surface 26 and an inner circumferential (bottom) surface 28 and opposing side surfaces 30. An annular rib 32 extends radially from the outer surface and an annular channel 34 is formed in the inner surface. Each side surface comprises an annular recess 36 circumferentially extending around the side of the annular gasket. The outer surface 26 is connected to the side surfaces 30 by a first pair of annular tapered surfaces 38, 40. The inner surface is connected to the side surface 30 by a second pair of annular tapered surfaces 42, 44. The gasket may have a symmetrical profile (e.g. a symmetrical cross sectional profile) about a radial axis 58.

The gasket comprises a single sealing area with each of the tubular members defined by the second pair of annular tapered surfaces and does not unload contact stress at the sealing area under internal or external pressure. The contact force at the sealing interface is increased by being double energised from the internal and external pressure.

The side surfaces 30 define the sides of the gasket which engage with the base of the recesses in the opposing end face surfaces of the tubular members. Although it is not necessary for contact between the side surfaces of the gasket and the base of the hub recess, this will typically occur during make-up, however the tolerance of the gasket will be such that contact between these surfaces does not limit the setting process.

The first pair of annular tapered surfaces comprises a first outwardly (upper) tapered surface 38 and second outwardly (upper) tapered surface 40 connected via the outer surface 26 from which the annular rib 32 extends therefrom. The second pair of annular tapered surfaces comprises a first inwardly (lower) tapered surface 42 and a second inwardly (lower) tapered surface 44 connected via the inner surface 28 from which the channel 34 extends therein.

The gasket 14 comprises an upper engaging section 46 and a lower sealing section 48. The outer surface 26, the outwardly facing tapered surfaces 38, 40, and the top sections of the side surfaces 30 form the upper engaging section 46 of the gasket. The inner surface 28, the inwardly facing tapered surfaces 42, 44 and the bottom section of the side surfaces 30 form the lower engaging portion 48 of the gasket. The lower engaging portion acts as the sealing portion of the gasket.

The gasket has an asymmetric cross-sectional profile with respect to the top and bottom portions of the gasket, i.e. the gasket is asymmetrical about a horizontal axis (as orientated in FIG. 3), parallel to the central bore axis. As can be seen in FIG. 3 the upper engaging portion 46 comprises a greater radial thickness than the lower engaging portion 48. The length of the side surfaces above the annular recess is greater than the length of the side surface below the annular recess. This mean that the distance (D1) between the outer surface 26 of the gasket to the first edge of the annular side recesses 36, is greater than the distance (D2) between the base of the channel 34 in the inner surface of the gasket to the second edge of the annular side recesses 36.

For example in one embodiment the distance from the base of the channel to the annular recess is about 10-30%, preferably 20-25%, of the total distance from the outer circumferential surface to the base of the channel in the inner circumferential surface.

Having a greater radial thickness for the upper engaging section enables large external pressure to be resisted without downwards movement of the gasket.

The gasket has a first inwardly sealing surface 42 configured to mate with the tapered inner sealing surface 22 of the first tubular member 10 and a second inwardly sealing surface 44 configured to mate with the tapered inner sealing surface 22 of the second tubular member 12. The gasket further comprises a first outwardly facing tapered surface 38 configured to engage with the tapered outer surface 20 of the first tubular member 10 and a second outwardly facing tapered surface 40 configured to engage with the tapered outer surface 20 of the second tubular member 12.

When the tubular members 10, 12 are clamped to each other, the inwardly sealing surface 22 of the first tubular member 10 is pressed against the first inwardly sealing surface 42 of the gasket and the inner sealing surface 22 of the second tubular member 12 is pressed against the second inwardly sealing surface 44 of the gasket, so as to thereby form a fluid-tight metal-to-metal seal between the gasket 14 and the tubular members 10, 12. This metal-to-metal seal constitutes a primary seal for the internal fluid pressure of the tubular joint.

As illustrated in the FIG. 3 the gasket comprises first and second inwardly sealing surfaces 42, 44 that are tapered and configured to mate with the respective first and second inner sealing surfaces 22 of the first 10 and second 12 tubular members respectively. The first and second inwardly sealing surfaces can have a rounded edge with the edge of the side walls forming the channel in the inner surface 28 of the gasket.

In one embodiment the first and second inner sealing surfaces can be tapered at an angle from about 60° to 75° to the horizontal. Preferably the surfaces are tapered at an angle (α) of from about 66° to 70°, more preferably from 68° to 68.5°.

The tapered first and second inwardly sealing surfaces act as the sealing faces of the gasket. This provides a resolved force to slide the gasket into position during make-up, this assists to set the gasket and provides a surface to surface sheering, to provide an improved seal. In addition to providing the sealing area of the gasket, the first and second inner sealing surfaces also resist movement from external pressure forces.

As shown in FIG. 3 the gasket comprises first 38 and second 40 outwardly tapered surfaces configured to mate with the respective first and second outer sealing surfaces 20 of the first 10 and second 12 tubular members respectively. In one embodiment the first and second outwardly tapered surfaces can be tapered at an angle from about 20° to 35°° to the horizontal. Preferably the surfaces are tapered at an angle (α) of from about 25° to 30°, more preferably from about 27.5° to 28.5°.

The first and second outwardly facing tapered surfaces act as displacement stop faces. The first and second outwardly facing tapered surfaces are at an angle to reduce the induced stress within the hub and to provide improved tolerance during the make-up process. External pressure acts on the first and second outwardly tapered surfaces. External pressure also acts at the top of the side surfaces. The first and second outwardly tapered surfaces also resist upwards forces from internal pressure. The angle of the outer taper surfaces contributes to the ability of the gasket to resist large external pressure without downward movement.

The inner surface 28 comprises an annular channel 34. The channel projects radially into the inner surface of the gasket and provides a circumferentially extending recess in the inner surface of the gasket. The width of the base of the channel (D4) constitutes a major portion of the width of the inner circumferential surface (D5). The channel can be shallow and may have depth such that it does not extend beyond where the inwardly tapered surfaces join to the side surfaces.

Referring to FIG. 3 in a cross-sectional view of the gasket, the side walls of the channel and inwardly tapered surfaces and the non-channel portion of the inner circumferential surface, define a pair of radially extending tapered fingers, with the annular channel extending thereinbetween.

In one embodiment the width of the base and opening of the channel comprises 60-95% of the width of the outer circumferential surface. The channel can have a depth of from about 5 mm-10 mm, preferably the channel has a depth of from 6 mm-7 mm.

Internal pressure energises the seal face and acts at the channel and forces the gasket into the sealing interfaces. Internal pressure acts on the sidewalls and base of the channel and pushes the gasket into the recess surfaces of the tubular member.

The gasket is provided with annular rib projection 32 on the outer surface 14 between the first 38 and second 40 outwardly facing tapered surface. The annular rib projects radially from the outer top surface of the gasket and extends around the outer circumference of the annular gasket. The annular rib is received by a space between the end faces of the first tubular member 10 and the second tubular member 12.

The rib may extend from a central portion of the outer circumferential surface. The rib can have a height of from 3 mm-10 mm, preferably the rib has a height of from 3.75 mm to 4.25 mm.

Referring to the embodiments as shown in FIG. 6, the sealing assembly comprises a seal plate 16 which carries the gasket. The seal plate 16 is provided between the end face of the first 10 and second 12 tubular members, such that the gasket is located coaxially inside the seal plate.

The inner surface of the seal plate is configured to hold the gasket. Referring to FIGS. 1, 2 and 6 the gasket 14 is connected to the seal plate via the projecting rib 32 on the outer surface of the gasket 14. An annular recess 50 in the inner surface of the seal plate and the rib 32 are configured such when the gasket is located within the seal plate that a gap is provided diametrically between the rib and the seal plate. This provides a space to allow the gasket to deflect radially outwards during makeup.

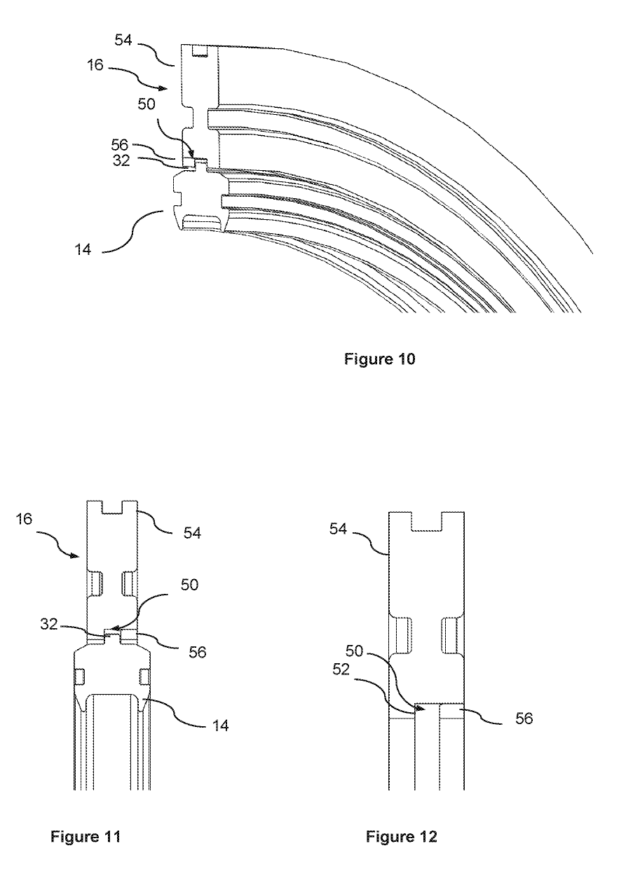

As shown in FIGS. 10 to 12 the seal plate 16 can comprise a first outer section 54 and a second inner section 56. The second inner section of the seal plate has a small diameter than the outer section of the seal plate and sits coaxially in the first outer plate to define an annular recess 50 in the inner surface of the seal plate. The rib 32 of the gasket extends into the recess 50.

The inner surface of the outer section 54 comprises a shoulder portion 52 extending radially therefrom, with the inner section 56 mounted in the outer section such that the outer surface of the inner section abuts a portion of the inner surface of the outer section such that the annular recess is defined between the side surface of the inner seal plate and the shoulder portion 52.

An annular recess 36 is provided in each of the side surfaces 30 of the gasket. The recesses are provided above the sealing faces of the gasket. The recesses are configured to each retain an annular sealing member (not shown). When mounted in the recess the sealing member will be coaxial with the annular gasket. These annular sealing members may be comprised of elastomeric material and are interposed between an end face of the tubular member and the side surface of the gasket.

The sealing assembly comprises can comprise two sealing members. A first annular sealing member is provided between the first side surface 30 of the gasket and the end face of the first tubular member 10. A second annular sealing member is provided between the second side surface 30 of the gasket and the end face of the second opposing tubular member 12.

The elastomeric seal member may be lip seals, where the seal is provided in one direction only, against internal pressure. Once the connection between the two tubular members is made up, a simulated external pressure can be applied. This will push the lip seals down and verify that the metal to metal seal is working effectively.

The gasket is particularly suitable for use for with large diameter conduits used in the subsea environment. The gasket can have a diameter of 20 inches (0.51 m) to 60 inches (1.52 m). Whilst dimensions for some of the features of the gasket have been provided above, these may vary depending on the size of the gasket. For example in a gasket having a 36 inch (0.92 m) diameter, the width of the gasket may be from about 25 mm to 35 mm, the height of the gasket from the top of the rib to the outer edge of the inner circumferential surface may be about 25 mm to 30 mm, with the rib having a height of about 3 mm to 10 mm, and the channel having a depth of about 5 mm to 10 mm.

The gasket is plastically set during the closure of the hubs. As the hubs come together and apply force to the gasket, the gasket is forced radially outwards and moves up the tapered transition in the end faces of the tubular members until further movement is prevented by the outward tapered surfaces of the gasket coming into contact with the opposing transition angled faces of the annular recesses of the tubular members. As the opposing transition angled faces of the annular recesses of the tubular members meet the outer tapered surfaces of the gasket, the side walls of the gasket and hubs will be coming into close contact and the hubs will now come into contact with the seal plate. Any further load applied will be applied to the seal plate and stored as preload.

During operation the external pressure generated from the hydrostatic pressure of the sea water, is exerted on the gasket. Pressure from the fluid in the bore of the tubular members, exerts an internal pressure on the inner circumferential surface of the gasket.

Application of internal pressure energises the seal face, the pressure acts at the internal recess in the inner surface of the gasket and forces the gasket into the metal sealing interfaces, upward forces are reacted by the outer taper walls of the hub that limited the gaskets deflection during setting. External pressure reacts on the outer circumferential surfaces, outwardly tapered surfaces, rib, and side surfaces, of the gasket, resulting in a downward force on the gasket. This resolved force from the external pressure further energises the metal to metal sealing interface. The contact force at the sealing interface is increased by being double energised from both the internal and external pressure.

The type and exact compositions of the material used to make the annular gasket is determined by amongst other factors, the corrosive nature of the environment in the which the seal is located, the temperature at which the seal is to be operated, and the material compatibility with the material to be used to form the conduit, in which the seal ring is to be used with. The material is preferably selected such that the tensile strength is sufficient on tightening of the joint that the gasket deflects elastically. The gasket is typically made from a different material than the hub faces of the tubular members. Typically the gasket is composed of a softer material than the hub faces of the tubular member.

The metallic gasket is typically made of a forged nickel alloy for example Alloy 625, Alloy 718 or Alloy X746. The configuration of the gasket means the gasket is able to be manufactured from a forged metal material, preferably a forged nickel alloy material, as the strength of the gasket during use is provided by being locked in between the hubs of the tubular members. This reduces the need to use stronger metal alloys, and/or the use of a stronger core material in the gasket, thereby reducing manufacturing costs.

The hubs with which the gasket is to be used with is typically made of an alloy steel, with a nickel alloy clad sealing face. The seal plate is also typically made from a metal alloy, such as steel alloy, for example a mild steel. The elastomeric seal members can comprise a material such as fluorocarbon elastomer (FKM).

The gasket and seal plate can be coated with a low friction coating. Coatings providing low coefficient of friction can be used on the surfaces of the gasket. Preferably the coating provides a friction co-efficient of about 0.02-0.06, preferably of about 0.04. A polymer coating, such as a polytetrafluoroethylene (PTFE) containing coating can be used. This helps prevent galling of the metal faces and helps sealing, by filing asperities at the sealing faces.

1. A metal gasket for providing a sealing connection between first and second tubular members, each tubular member having an end face comprising an annular recess for receiving the gasket, each recess comprising tapered side walls, the gasket comprising:
two opposing side surfaces, each side surface comprising an annular recess for receiving a sealing member;
an outer circumferential surface comprising an annular rib portion;
an inner circumferential surface comprising a channel;
wherein the gasket further comprises;
a first pair of annular tapered surfaces between the side surface and the outer circumferential surface; and
a second pair of annular tapered surfaces between the side surface and the inner circumferential surface.

2. A metal gasket as claimed in claim 1 wherein the distance from base of the channel located in the inner surface to the side surface recess is smaller than the distance from the outer surface to the side surface annular recess.

3. A metal gasket as claimed in claim 1 wherein the channel has a depth of from 5 mm to 10 mm.

4. A metal gasket as claimed in claim 1 wherein the rib has a height of from 3 mm to 10 mm.

5. A metal gasket as claimed in claim 1 where the first pair of tapered surfaces are tapered at a first angle and the second pair of tapered surfaces are tapered at a second angle, wherein the first and second angles are different.

6. A metal gasket as claimed in claim 1 wherein the second pair of tapered annular surfaces taper at an angle of from about 60° to about 75°.

7. A metal gasket as claimed in claim 1 wherein the second pair of tapered annular surfaces taper at an angle of from about 68° to about 68.5°.

8. A metal gasket as claimed in claim 1 wherein the first pair of tapered annular surfaces taper at an angle of from about 20° to about 35°.

9. A metal gasket as claimed in claim 1 wherein the first pair of tapered annular surfaces taper at an angle of from about 27.5° to about 28.5°.

10. A metal gasket as claimed in claim 1 wherein the distance from the outer circumferential surface to the annular recess is greater than the distance from the base of the channel to the annular recess.

11. A metal gasket as claimed in claim 1 wherein the distance from the base of the channel to the annular recess is about 10-30% of the total distance from the base of the channel to the outer circumferential surface.

12. A sealing assembly for providing a sealing connection between first and second tubular members, each tubular member having an end face comprising an annular recess for receiving a gasket, the recess comprising tapered side walls, the sealing assembly comprising:
a metal gasket having:
two opposing side surfaces, each side surface comprising an annular recess for receiving an annular sealing member;
an outer circumferential surface comprising an rib portion;
an inner circumferential surface comprising a channel;
the gasket further comprising a first pair of annular tapered surfaces between the side surfaces and the outer circumferential surface; and
a second pair of annular tapered surfaces between the side surfaces and the inner circumferential surface and a second pair;
an annular seal plate for retaining the metal gasket coaxially to the seal plate, the seal plate comprising an annular recess located in its inner surface for retaining the rib of the metal gasket; and
annular sealing members for mounting the annular recess of the side walls of the gasket.

13. A sealing assembly as claimed in claim 12 wherein the annular sealing members are elastomeric sealing members.

14. A sealing assembly as claimed in claim 12 wherein the annular seal plate comprises an outer plate and an inner plate, wherein the inner plate has a smaller diameter than the outer plate; and is mounted coaxially with the outer seal plate to define the annular recess thereinbetween.

15. A sealing assembly as claimed in claim 12 wherein the metal gasket is defined as in claim 1.
